(19) United States
(12) Patent Application Publication
(10) Pub. No.: US 2009/0000386 A1
(43) Pub. Date: Jan. 1, 2009

(54) FAIRING AND INSTALLATION METHODOLOGY FOR SENSOR PRESSURE BELTS

(76) Inventors: Lawrence C. Paradis, Issaquah, WA (US); Steven B. Brown, Dupont, WA (US); Matt R. Dickerson, Renton, WA (US)

Correspondence Address: KLEIN, O'NEILL & SINGH, LLP, 43 CORPORATE PARK, SUITE 204, IRVINE, CA, 92606, US

(21) Appl. No.: 12/050,875

(22) Filed: Mar. 18, 2008

Related U.S. Application Data
(63) Continuation-in-part of application No. 11/078,984, filed on Mar. 11, 2005, now Pat. No. 7,350,752.

(51) Int. Cl. G01L 7/00; B23P 11/00

(52) U.S. Cl. 73/700; 29/428; 244/129.1

(57) ABSTRACT

A fairing system developed to reduce the flow disturbance around sensor elements allowing accurate measurement of the pressure distribution on an object surface. The fairing also protects the sensors and electronics of the pressure belt from direct exposure to airflow.

### CROSS-REFERENCE TO RELATED APPLICATIONS

This application is a continuation-in-part of application Ser. No. 11/078,984, filed on Mar. 11, 2005, the entire contents of which are hereby incorporated by reference.

### BACKGROUND

1. Technical Field

The present embodiments relate generally to a fairing system developed to reduce the flow disturbance around sensor elements allowing accurate measurement of the pressure distribution on an airplane exterior surface.

2. Related Art

The ability to measure the pressure distribution across an airplane external surface is a requirement for Flight Test. To measure pressure distribution, tubing has been glued to the external surface and plumbed to pressure sensors positioned in a remote location. This solution has proved to be labor intensive, expensive to install and troublesome to maintain.

A sensor pressure belt has been developed which locates the sensor at the required measurement location. For example, in U.S. Pat. No. 6,134,485, a system and method for analyzing physical parameters of flight data is described, which includes a multi-sensor system having an array of belts. Each belt includes a plurality of interconnected belt segments including a substrate having an electrically conductive digital data bus, and at least one module having a first sensor, a second sensor and a digital signal processor and a coating for protecting the belt segment. The first and second sensors, which are preferably formed as micro-electromechanical sensors sharing a common substrate, respectively generate signals representative of a first physical parameter and a second physical parameter. The processor receives and analyzes the first and second signals to generate a third signal. The third signal is transmitted along the electrically-conductive bus to a remotely-located controller. The controller analyzes the third signal to obtain flight status information relating to the effect of the physical parameters on the flight. U.S. Pat. No. 6,134,485 is incorporated herein by reference. Unfortunately, the pressure belt may not be suitable to be exposed directly to airflow.

Accordingly, what is needed is a mechanism to protect the sensors, create a smooth aerodynamic surface over the pressure belt without changing sensor performance and maintain the integrity of the installation in flight.

### SUMMARY

The present embodiments provide a fairing system developed to reduce the flow disturbance around sensor elements allowing accurate measurement of the pressure distribution on an airplane exterior surface. The fairing also protects the sensors and electronics of the pressure belt from direct exposure to airflow.

The fairing system includes a fairing assembly that can include shim stock and a thin rubber pad or substrate. The fairing assembly is configured to cover a sensor pressure belt, contour to the electronics on the belt and provide access at appropriate locations to allow for the measurement of pressure.

The fairing assembly is shaped such that when installed on the airplane surface it minimizes the flow disturbance across the pressure sensing element allowing an accurate measurement of the local pressure. The fairing assembly is attached to the airplane surface using conventional methods, such as tape for ease of installation.

In one aspect of the present embodiments, a fairing system is provided that includes a multisensor system for measuring physical parameters at a plurality of discrete locations about a surface of an object; and a fairing assembly including an aerodynamically configured surface having a central access portion in which the multisensor system is disposed. The fairing assembly provides environmental access to the multisensor system to measure local pressure on the surface.

In yet another aspect of the present embodiments, a method is provided for assembling a fairing system. The method includes positioning a pressure sensing element at a measurement location on an object surface; positioning a substrate over the pressure sensing element; bonding a CRES sheet to the substrate; and forming a pressure port hole to provide environmental access to the pressure sensing element; and positioning a fairing body over the pressure sensing element, the substrate and the CRES sheet.

In yet another aspect of the present embodiments a method is provided for assembling a fairing system. The method comprises positioning a plurality of pressure sensing elements on a belt segment, and securing the belt segment on an object surface to thereby position the pressure sensing elements at a plurality of discrete measurement locations on the object surface. The method further comprises positioning a substrate over the belt segment and the pressure sensing elements. The substrate includes a plurality of cavities, and at least some of the cavities contain the pressure sensing elements. The method further comprises positioning a cover sheet over the substrate, and forming a plurality of pressure port holes in the cover sheet. Each pressure port hole is located so as to provide environmental access to one of the pressure sensing elements. The method further comprises positioning a fairing body over the pressure sensing elements, the substrate and the cover sheet. The fairing body includes first and second aero wedges disposed to either side of a central access portion in which the pressure sensing elements are disposed. The fairing body provides environmental access to the pressure sensing elements.

In yet another aspect of the present embodiments, a sensor package on an object surface is provided. The sensor package comprises a plurality of pressure sensing elements at a plurality of discrete locations on the object surface. A belt segment locates the pressure sensing elements at the discrete locations. A substrate overlies the belt segment. The substrate includes a plurality of cavities, and at least some of the cavities contain the pressure sensing elements. A cover sheet overlies the substrate. The cover sheet includes a plurality of port holes, and each port hole is located over one of pressure sensing elements. A fairing assembly including first and second aero wedges is disposed to either side of a central access portion in which the pressure sensing elements are disposed. The fairing assembly provides environmental access to the pressure sensing elements.

The fairing system and installation method reduce installation flow time during an airplane test program. The fairing makes the airplane installation of the pressure belts efficient and thus reduces flight test costs.

Additional advantages, objects, and features of the present embodiments will be set forth in part in the detailed description which follows. It is to be understood that both the foregoing general description and the following detailed description are merely exemplary of the present embodiments, and are intended to provide an overview or framework for understanding the nature and character of the present embodiments as they are claimed.

### BRIEF DESCRIPTION OF THE DRAWINGS

The accompanying drawings are included to provide further understanding of the present embodiments, illustrate the various embodiments, and together with the description serve to explain the principles and operation of the present embodiments. In the drawings, the same components have the same reference numerals. The illustrated embodiments are intended to illustrate, but not to limit the present embodiments. The drawings include the following figures:

FIG. 1 is a schematic block diagram of an aircraft:

FIG. 2 is a simplified top view of a fairing system in accordance with the present embodiments;

FIG. 3 is a simplified sectional view of the fairing system of FIG. 2;

FIG. 4 is a simplified sectional view of the fairing system of FIG. 2; and

FIG. 5 is a flowchart describing one embodiment of a method of assembling the present fairing system.

### DETAILED DESCRIPTION

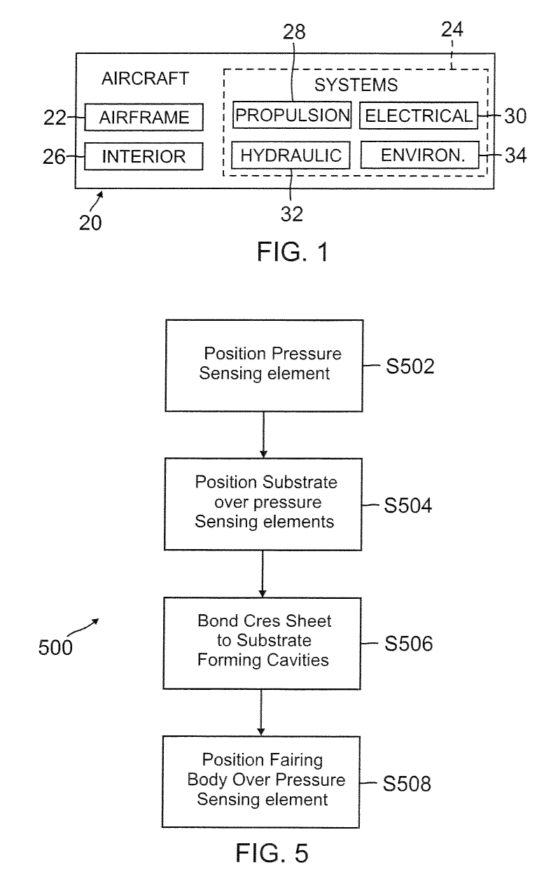

FIG. 1 schematically illustrates one embodiment of an aircraft. Embodiments of the present fairing and installation methodology for sensor pressure belts are adapted to be installed on an aircraft surface, such as on a wing, a fuselage, a tail or a door. The aircraft 20 includes an airframe 22 with a plurality of systems 24 and an interior 26. Examples of high-level systems 24 include one or more of a propulsion system 28, an electrical system 30, a hydraulic system 32, and an environmental system 34. Any number of other systems may be included, as those of ordinary skill in the art will appreciate. Further, although an aerospace example is shown, the principles of the present embodiments may be applied to other industries, such as the automotive industry.

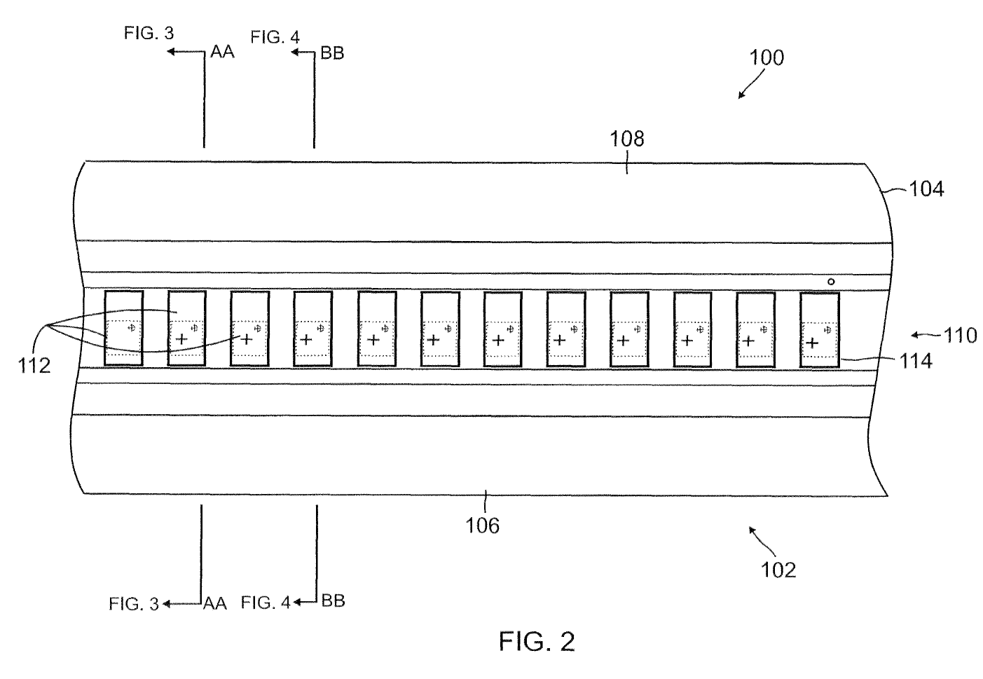

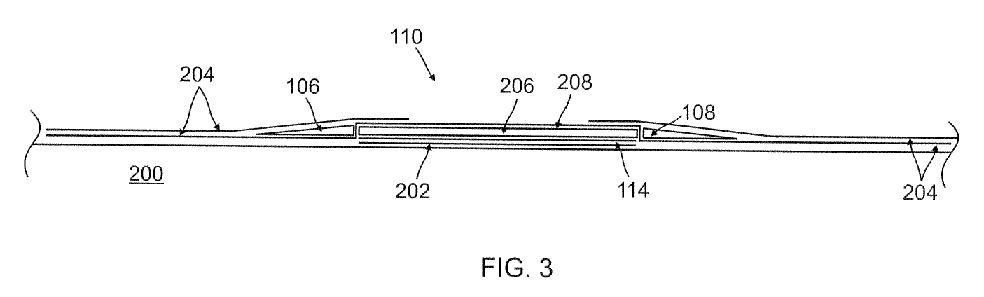

FIG. 2 is a simplified view of one embodiment of the present fairing system 100. Fairing system 100 includes a fairing assembly 102 having an outer fairing body 104 defined by aero wedges 106 and 108 formed about a central access portion 110. Fairing assembly 102 also includes a substrate 206 and a cover sheet 208 shown in FIG. 3. The cover sheet 208 may comprise, for example and without limitation, a metal such as corrosion resistant steel (CRES), aluminum, titanium, etc., a plastic or a composite. Generally, disposed within central access portion 110 is at least one pressure sensing element 112 for analyzing physical parameters of flight data. In one embodiment, pressure sensing element 112 is coupled to belt segment 114, which locates at least one pressure sensing element 112 at the required measurement location.

Fairing assembly 102 is configured to cover pressure sensing element 112 and belt segment 114 by being made to contour to the electronics on belt segment 114. Fairing assembly 102 provides access to ambient air at appropriate locations to allow for the measurement of pressure.

Fairing body 104 is shaped such that, when installed on an airplane surface, it minimizes the flow disturbance across pressure sensing element 112 allowing an accurate measurement of the local pressure. Fairing body 104 can be made of any suitable material. For example and without limitation, the fairing body 104 may comprise a metal such as stainless steel shim stock, aluminum, titanium, etc., a plastic or a composite.

FIG. 3 provides a sectional view of the fairing assembly 102 cut across belt segment 114. As shown in FIG. 3, belt element 114 is coupled to airplane surface 200 using, for example, single or double sided tape and the like, such as without limitation 3M #92 tape.

Fairing assembly 102 can be coupled to airplane surface 200 and made to surround belt segment 114 with aero wedges 106 and 108. In this embodiment, belt segment 114 may be disposed within central portion 110 of fairing assembly 102 between aero wedges 106 and 108. Fairing assembly may be mounted to airplane surface 200 using conventional methods, such as tape 204 and the like, for example and without limitation, 3M Y434 aluminum tape, for ease of installation.

When properly positioned, a substrate 206 may be positioned over belt segment 114. Substrate 206 can be made of any suitable thickness and material. In one embodiment, substrate 206 can be made of neoprene rubber to a thickness of about 3/32″ and the cover sheet 208 can be made of CRES having a thickness of about 0.005″. The cover sheet 208 may be bonded to substrate 206.

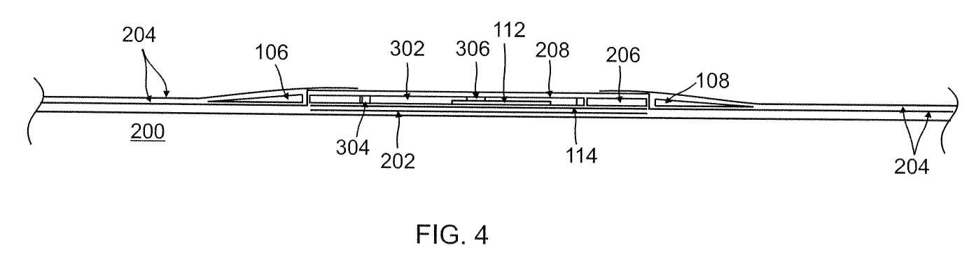

FIG. 4 provides a sectional view of fairing assembly 102 cut across belt segment 114 and pressure sensing element 112. In contrast to FIG. 3, FIG. 4 shows a cavity 302 formed by removal of a portion of substrate 206 under the cover sheet 208. Cavity 302 provides space for pressure sensing element 112 and other discrete components formed on belt segment 114 while covered by fairing assembly 102. Sealant 304 is provided to seal cavity 302.

In one embodiment, at a prescribed location generally positioned above pressure sensing element 112 is formed a pressure port hole 306. Pressure port hole 306 may allow for the measurement of local pressure by pressure sensing element 112 without the disturbance caused by turbulent airflow. Pressure port hole 306 can be of any suitable diameter, for example, 0.063″ diameter.

It should be understood, as shown in FIG. 2, that belt element 114 can include a plurality of pressure sensing elements 112. Accordingly, fairing assembly 102 includes a plurality of port holes 306 formed on the cover sheet 308 above each pressure sensing element 112.

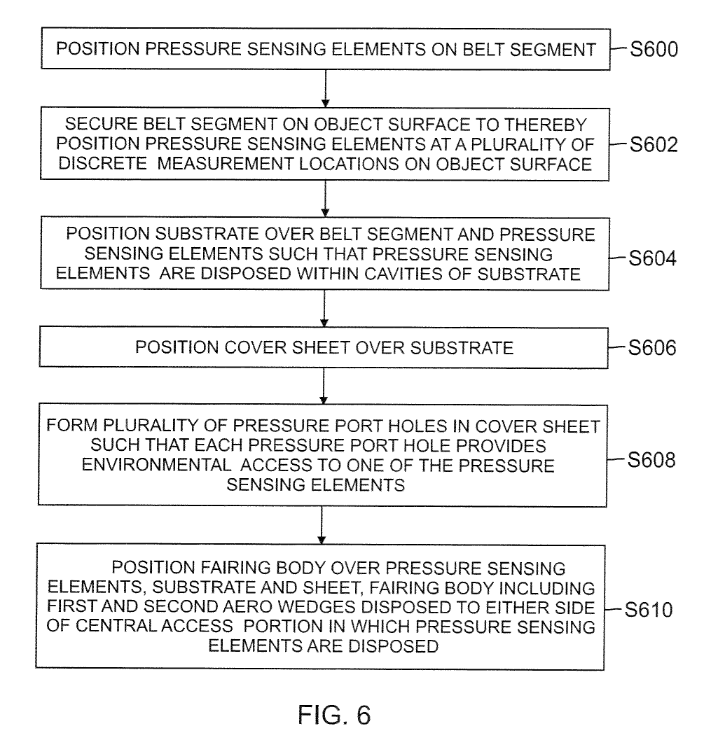

FIG. 5 is a flowchart describing an assembly method 500 of forming fairing system 100 on the surface of an object. In step S502, a pressure sensing element is positioned at a measurement location on an object. In one embodiment, a plurality of pressure sensing elements 112 disposed on belt element 114 are secured by tape to the surface of an aircraft. The aircraft surface may be, for example, a wing a fuselage, a tail or a door.

In step S504, substrate 206 is positioned over belt segment 114 and pressure sensing element 112. Substrate 206 includes a hole which allows substrate 206 to be placed over belt element 114 and allow pressure sensing element 112 to emerge through substrate 206. In step S506, the cover sheet 208 is bonded to substrate 206. When bonded to substrate 206, the area over the hole forms cavity 302 in which pressure sensing element 112 resides. In one embodiment, a sealant 304 can be used to seal cavity 302.

A pressure port hole 306 is formed in the cover sheet 208 to provide access to otherwise sealed cavity 302 to allow for the measurement of local pressure. In step S508, fairing body 104 including aero wedges 106 and 108 is positioned over belt element 114, pressure sensing element 112, and substrate 206, such that belt element 114 resides in central portion 110 of fairing assembly 102. Firing body 104 is secured to airplane surface 200 using tape 204 for ease of installation.

FIG. 6 illustrates steps in one embodiment of the present methods for assembling a fairing system. In step S600, a plurality of pressure sensing elements are positioned on a belt segment. In step S602, the belt segment is secured on an object surface to thereby position the pressure sensing elements at a plurality of discrete measurement locations on the object surface. As described above, the object surface may be an aircraft surface, such as a wing, a fuselage, a tail or a door. In step S604, a substrate is positioned over the belt segment and the pressure sensing elements. The substrate includes a plurality of cavities, and at least some of the cavities contain the pressure sensing elements. In step S606, a cover sheet is positioned over the substrate. As described above, the cover sheet may comprise a metal, a plastic or a composite.

In step S608, a plurality of pressure port holes are formed in the cover sheet. Each pressure port hole is located so as to provide environmental access to one of the pressure sensing elements. In step S610, a fairing body is positioned over the pressure sensing elements, the substrate and the cover sheet. The fairing body includes first and second aero wedges disposed to either side of a central access portion in which the pressure sensing elements are disposed. The fairing body provides environmental access to the pressure sensing elements.

The above description presents the best mode contemplated for carrying out the present fairing and installation methodology for sensor pressure belts, and of the manner and process of making and using it, in such full, clear, concise, and exact terms as to enable any person skilled in the art to which it pertains to make and use this fairing and installation methodology for sensor pressure belts. This fairing and installation methodology for sensor pressure belts is, however, susceptible to modifications and alternate constructions from that discussed above that are fully equivalent. Consequently, this fairing and installation methodology for sensor pressure belts is not limited to the particular embodiments disclosed. On the contrary, this fairing and installation methodology for sensor pressure belts covers all modifications and alternate constructions coming within the spirit and scope of the fairing and installation methodology for sensor pressure belts as generally expressed by the following claims, which particularly point out and distinctly claim the subject matter of the fairing and installation methodology for sensor pressure belts.

What is claimed is:

1. A method for assembling a fairing system comprising:
positioning a plurality of pressure sensing elements on a belt segment;
securing the belt segment on an object surface to thereby position the pressure sensing elements at a plurality of discrete measurement locations on the object surface;
positioning a substrate over the belt segment and the pressure sensing elements, the substrate including a plurality of cavities, at least some of the cavities containing the pressure sensing elements;
positioning a cover sheet over the substrate;
forming a plurality of pressure port holes in the cover sheet, each pressure port hole being located so as to provide environmental access to one of the pressure sensing elements; and
positioning a fairing body over the pressure sensing elements, the substrate and the cover sheet;
wherein the fairing body includes first and second aero wedges disposed to either side of a central access portion in which the pressure sensing elements are disposed, the fairing body providing environmental access to the pressure sensing elements.

2. The method of claim 1, further comprising sealing the cavities containing the pressure sensing elements.

3. The method of claim 1, further comprising the step of bonding the cover sheet to the substrate.

4. The method of claim 1, wherein the object surface comprises an aircraft body surface.

5. The method of claim 1, wherein the fairing body is contoured to accommodate electronics located on the belt segment.

6. The method of claim 1, wherein the fairing body creates limited flow disturbance across the pressure sensing elements to allow accurate measurements of local pressures.

7. The method of claim 1, wherein the substrate is neoprene rubber.

8. The method of claim 7, wherein the substrate has a thickness of about 0.09375 inches.

9. The method of claim 1, wherein the cover sheet is corrosion resistant steel (CRES).

10. The method of claim 9, wherein the CRES sheet has a thickness of about 0.005 inches.

11. A sensor package on an object surface, the sensor package comprising:
a plurality of pressure sensing elements at a plurality of discrete locations on the object surface;
a belt segment configured to locate the pressure sensing elements at the discrete locations;
a substrate overlying the belt segment, the substrate including a plurality of cavities, at least some of the cavities containing the pressure sensing elements;
a cover sheet overlying the substrate, the cover sheet including a plurality of port holes, each port hole being located over one of pressure sensing elements; and
a fairing assembly including first and second aero wedges disposed to either side of a central access portion in which the pressure sensing elements are disposed, the fairing assembly providing environmental access to the pressure sensing elements.

12. The sensor package of claim 11, wherein the cover sheet comprises a metal, a plastic or a composite.

13. The sensor package of claim 11, wherein the cover sheet is bonded to the substrate.

14. The sensor package of claim 1, wherein the object surface comprises an aircraft body surface.

15. The sensor package of claim 11, wherein the substrate is neoprene rubber.

16. The sensor package of claim 15, wherein the substrate has a thickness of about 0.09375 inches.

17. The sensor package of claim 11, wherein the cover sheet is corrosion resistant steel (CRES).

18. The sensor package of claim 17, wherein the CRES sheet has a thickness of about 0.005 inches.
